(19) United States
(12) Patent Application Publication
(10) Pub. No.: US 2005/0267981 A1
(43) Pub. Date: Dec. 1, 2005

(54) System and method for server side detection of client side popup blocking

(76) Inventors: Alan Brumley, Austin, TX (US); David Schmidt, Round Rock, TX (US)

Correspondence Address: HAMILTON & TERRILE, LLP, P.O. BOX 203518, AUSTIN, TX, 78720, US

(21) Appl. No.: 10/844,946

(22) Filed: May 13, 2004

(51) Int. Cl. G06F 15/16

(52) U.S. Cl. 709/232

(57) ABSTRACT

Server side detection of client popup blocking is performed by a popup verification engine that inserts a popup window command in a response to a client request of a download and detects client popup blocking where a request by the client to download the popup window is not received in a predetermined time period. A unique identification code generator generates unique identification codes which are inserted into content to generate a popup window. Detection of an HTTP request, such as a referrer tag having the unique identification code, at a server indicates a client request for the popup window, which is confirmed by subsequent download requests, such as a graphics request. Corrective action is taken for clients that block popups to ensure that the client is able to download content from the server, such as re-directing the client to a network site that does not use popups or giving a notice to the user of the client to disable popup blocking.

### BACKGROUND OF THE INVENTION

1. Field of the Invention

The present invention relates in general to the field of information handling system network communication, and more particularly to a system and method for server side detection of client side popup blocking.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often interact with each other through networks, such as the Internet-based World Wide Web. In order to simplify and enable networked communication, industry has set standards for networked communications to perform desired functions. For instance, information handling systems communicate through the World Wide Web with browsers located on clients that download information from servers via hypertext transfer protocol (HTTP). An individual HTTP request is sent for each element on a Web page and clients perform desired functions defined by the downloaded information, such as display of graphics, display of hypertext markup language (HTML) in frames, and performing functions defined by java classes. As the World Wide Web has developed over the past several years, a rich environment of design tools have allowed interesting and entertaining presentation of information in client browsers. One example of a powerful tool for presentation of information is the popup window. Content downloaded by a client browser include instructions that result in the creation and downloading of information to a popup browser window from an identified Web page. Thus, Web page designers often include popup windows that break down information into more easily understood sections, such as popup windows that provide help or additional information about a product or issue that a user may conveniently reference.

Unfortunately, the powerful tools available through the World Wide Web, such as popup windows, are often over used, such as to advertise. Popup advertisements have become so common that overwhelmed and annoyed users often install popup blocking applications to prevent their browsers from performing scripts that download any popup windows. Indeed, information handling system user frustration with popup advertisements has become so great that updated browser releases include popup blocking as a native function. Typically, popup blocking applications are designed to work in stealth so that servers cannot detect that blocking is in use. Although stealthy popup blocking software is helpful to users seeking to avoid annoying advertising, it tends to interfere with desired website functionality without warning or notice to the server. When a client uses a popup blocking application, valid and desired popups containing user-requested information are often blocked without a visual or audio cue at the client. As a result, links or buttons displayed at the client that command a popup related function often are inoperable leaving frustrated users with a poor impression of the Website. Users can typically avoid such problems by setting the popup blocking applications to enable popup technology on selected Websites, however, users generally are not aware of the problem since the popup blocking applications generally do not give cues when a popup is blocked. Alternatively, websites that use popup windows in a manner approved by a user may download applications to reside on client systems to monitor and correct popup blocking of desired popup functions, however, the client user generally must permit such applications.

### SUMMARY OF THE INVENTION

Therefore a need has arisen for a system and method which performs server side detection of client side popup blocking.

In accordance with the present invention, a system and method are provided which substantially reduce the disadvantages and problems associated with previous methods and systems for communicating popup windows from a server for display at a client. A popup window request is inserted by the server in the response to a client request for a download of content. The server determines that the client is blocking popup windows if the client fails to make the popup window request within a predetermined time period. In order to identify clients, the popup window request includes a unique identification code that is returned with the popup window request, such as a unique referrer code.

More specifically, a popup verification engine associates a unique identification code with a popup window request inserted in content selected for download by a client. The unique identification code is generated by a unique identification code generator and inserted in initial content requested by the client. The unique identification code is included in the popup generating code which resides in the initial content so that client execution of popup generating code includes the unique identification code in a request to the server, such as a unique referrer tag or unique request parameter. The popup verification engine scans requests from the client interface to determine whether the client associated with the unique identification is blocking popup windows. If the content interface receives a popup window content request having the unique identification code, then the client is determined to allow popup windows. If the content interface fails to receive a popup window content request made with the unique identification code before a predetermined timeout, then the client is determined to have popup blocking. Corrective action taken on detection of popup blocking includes redirecting the client to a network site that does not use popups or sending a notice to the user of the client that popup blocking is interfering with desirable functions and instructing the user how to disable popup blocking.

The present invention provides a number of important technical advantages. One example of an important technical advantage is that server side detection of client popup blocking allows server side corrective action where popup blocking has unintended consequences to client functions associated with information downloaded from the server. For instance, if a server detects that popup blocking occurs at a client, the server may redirect the client to another site that uses an alternative to popup technology. Alternatively, the server may provide the client with notice that desired functions are blocked and suggest that the client disable the popup blocking for the site. As a minimum, providing notice to the user of the impact of popup blocking allows the user to understand that poor quality is related to client settings instead of website quality.

Another important technical advantage of the present invention is that server side detection does not depend upon applications on the client that a user may inadvertently or intentionally disable. For example, a cookie in the browser of a client may track or identify popup blocking but cookies are easily deleted or disabled by users concerned about security and privacy. Similarly, client applications that are loaded without a user's knowledge and agreement present security and privacy concerns, especially applications that track information handling system capabilities, and such applications are often deleted by users, such as with spyware applications.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for detecting popup blocking; and

FIG. 2 depicts a flow diagram of a process for detecting popup blocking.

### DETAILED DESCRIPTION

Server side detection of popup blocking allows corrective action to ensure communication of information between server and client information handling systems whether or not the client allows popup windows. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

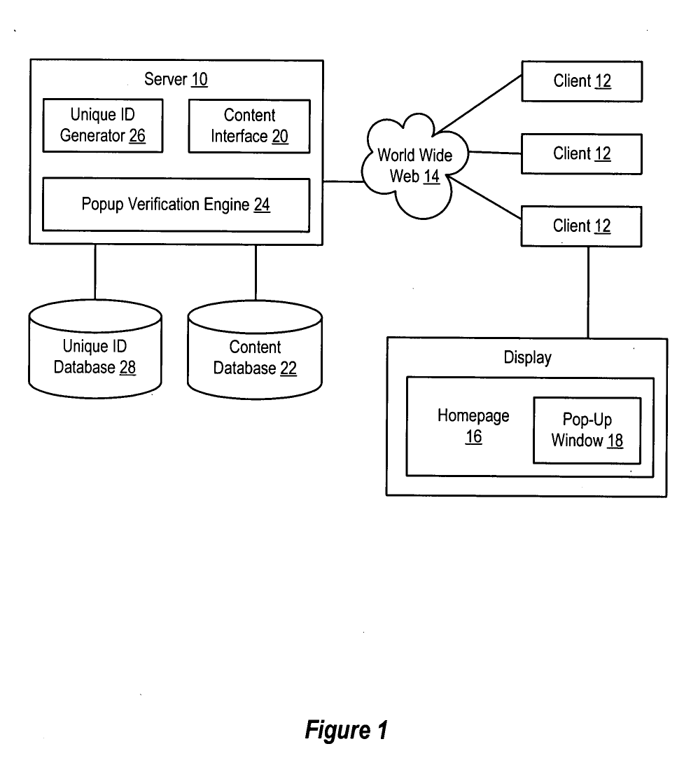

Referring now to FIG. 1, a block diagram depicts a system for server side detection of client popup blocking. Server information handling system 10 communicates with plural client information handling systems 12 through a network 14, such as the World Wide Web. Clients 12 download information, such as Web pages retrieved through a browser for presentation on a display, such as a home page 16 and a popup window 18. Home page 16 downloads after a user selection of an address through a browser that initiates instructions for client 12 to perform an individual HTTP request for each element on home page 16. An example of a typical HTTP request is:
GET/border.gif HTTP/1.1
Accept: */*
Accept-Language: en-us
Connection: Keep-Alive
Host: www.dell.com
Referrer: http://www.dell.com/index.html
User-Agent: Mozilla (X11; I; Linux 2.0.32 i586)
   The request is for a graphic called border.gif, includes information about the browser and environment of client 12, identifies the domain name used to reach the website, and includes a referrer tag which tracks where the user was before selection of the current page or, in this example, tracks the page asking for the loading of the graphic. Popup window 18 results when server 10 sends page content containing instructions for client 12 to make a popup window which will request its own content from an identified network site. Popup blocking applications prevent the execution of such popup window requests.

Server information handling system 10 communicates information to clients 12 through a content interface 20 from a content database 22. For instance, a client 12 requests a home page with a “GET /index.htm HTTP/1.1” request. Server 10 includes a popup verification engine 24 that detects popup blocking on clients 12 by requesting a unique identification code for the client from a unique identification generator 26. Popup verification engine 24 embeds the unique identification code into a popup source link that is sent to the client along with links to download the homepage, such as the “GET /border.gif” command set forth above. Next, the separate popup window is spawned and issues its own request to server 10 with “GET /popup.htm?UID-XXX HTTP/1.1” with a referrer tag that identifies “www.dell.com/index.html” as referring network location. In alternative embodiments, the content and popup verification functions of server 10 may be distributed across plural information handling systems.

Popup verification engine 24 monitors content interface 20 to detect the client request with the unique identification code. For instance, popup verification engine 24 determines that a client associated with the unique identification code is blocking popup windows if the content interface fails to receive a popup window content request made before a predetermined timeout and having the unique identification code If the popup verification engine fails to detect a client request with the unique identification code in a predetermined time, such as a predetermined time after the border.gif is requested, then the popup verification engine determines that the associated client is blocking popups. Detection of popup blocking allows server 10 to take corrective action by setting session variables that direct the associated client to network sites that do no use popups or that provide a notice to the client that popup blocking is having an undesired impact along with instructions on how to disable popup blocking. If a client request with the unique identification code is detected, popup verification engine 24 determines that the associated client is popup capable and sets a session variable to continue communication with the client using popup enabled network locations. For instance, a unique identification database 28 associates popup enabled clients and session variables with unique identifications codes, and, in one embodiment, with more permanent identification, such as a cookie loaded on the associated client. In one embodiment, a second level of verification occurs with the detection of additional content by the client that includes the unique identification code in the referrer tag, such as a graphics, text or java class request. This indicates that the popup request is not being hindered by popup blocking software. In another embodiment, the popup window includes a script that automatically closes the window to prevent interference with display of desired information at the client.

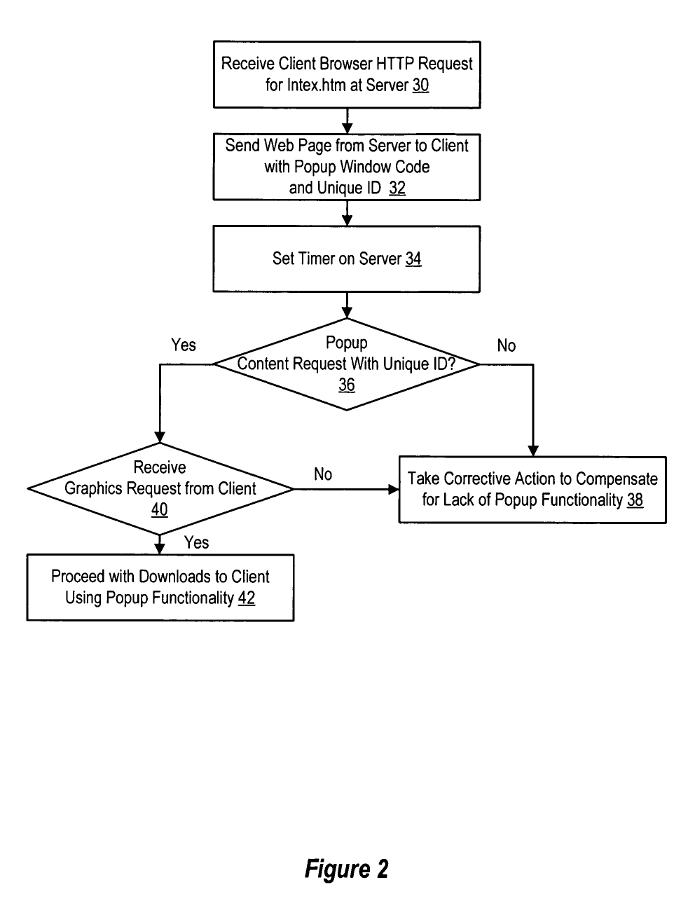

Referring now to FIG. 2, a flow diagram depicts a process for server side detection of client popup blocking. The process begins at step 30 with receipt of a client information handing system browser HTTP request for an index.htm of a network site homepage. At step 32, the server information handling system responds to the client request by sending web page information from the server to the client having popup window script code with an embedded unique identification code as the referrer tag for a subsequent request by the client for the popup window. At step 34, the server sets a timer for detecting download of the popup window in a predetermined time, such as a predetermined time after the client makes HTTP requests in response to the index.htm to download the homepage. At step 36, a determination is made at the server of whether a popup window request is received with the unique identification code within the predetermined time. If no popup window request is received, the process continues to step 38 at which the server takes corrective action to compensate for the lack of popup functionality, such as redirecting the client to another site or sending a notice to the client of a need to disable popup blocking. If the determination at step 36 is yes due to detection at the server of a popup HTTP request with the unique identification code, the process continues to step 40 for a second level verification of popup functionality by a determination that a graphic request is received at the server having a referrer tag with the unique identification code. If the second level verification fails to detect a graphics request, the process determines blocking of popup functionality and continues to step 38. If the second level verification confirms popup functionality, the process continues to step 42 to allow client downloads to proceed with content that includes popup functionality.

Although the present invention has been described in detail, it should be understood that various changes, substitutions and alterations can be made hereto without departing from the spirit and scope of the invention as defined by the appended claims.

1. An information handling system for communicating information through a network to plural clients, the information handling system comprising:
a content interface operable to communicate content selected by a client through the network to the client;
a unique identification generator operable to generate a unique identification code for each client that communicates with the content interface; and
a popup verification engine operable to associate the unique identification code with a popup window request inserted in the selected content and to determine that the client associated with the unique identification is blocking popup windows if the content interface fails to receive a popup window request made before a predetermined timeout and having the unique identification code.

2. The information handling system of claim 1 wherein the popup verification engine is further operable to command the content interface to take corrective action for clients determined to be blocking popup windows.

3. The information handling system of claim 2 wherein the corrective action comprises directing the client to popup free content.

4. The information handling system of claim 2 wherein the corrective action comprises sending content to the client that requests the client to disable popup blocking.

5. The information handling system of claim 2 wherein the popup verification engine is further operable to track clients determined in a first session as popup blocking in order to command content interface to take corrective action in subsequent sessions.

6. The information handling system of claim 1 wherein the popup verification engine is further operable to determine that the client associated with the unique identification is blocking popup windows if the content interface fails to receive a popup window graphics content request made before a predetermined timeout and having the unique identification code.

7. The information handling system of claim 1 wherein the popup window command comprises embedded scripts that automatically close the popup window.

8. The information handling system of claim 1 wherein the unique identification code comprises an HTTP request.

9. A method for communicating information from one or more servers through a network to plural clients, the method comprising:
receiving at a server a client request to download information;
generating an identification code for the client;
inserting the identification code in a popup request;
downloading the popup request to the client;
monitoring client requests to detect a request having the identification code; and
determining that the client is blocking popups if the identification code is not detected in a predetermined time.

10. The method of claim 9 further comprising:
detecting a request having the identification code;
detecting a subsequent request associated with the identification code and graphics information; and
determining that the client is popup enabled.

11. The method claim 9 further comprising taking corrective action at a server to download information to the client.

12. The method of claim 11 wherein the corrective action comprises directing the client to popup free content.

13. The method of claim 11 wherein the corrective action comprises sending a message to the client to modify the popup blocking.

14. The method of claim 9 wherein inserting the identification code further comprises inserting a unique code into homepage content resulting in the unique code appearing as a referer tag to the popup window request.

15. The method of claim 9 further comprising embedding a script in the popup to automatically close at the client.

16. The method of claim 9 further comprising setting a session variable that identifies clients that block popups.

17. A system for server side detection of popup blocking by one or more of plural clients, the system comprising:
an identification code generator operable to generate an identification code for each of plural clients; and
a popup verification engine operable to associate the identification codes with referrer tags of popup window requests sent to each of the clients and to determine that a client associated with an identification code is blocking popup windows if the client fails to send a popup window request with the associated referrer tag.

18. The system of claim 17 wherein the popup verification engine is further operable to detect popup functions associated with a client are enabled by determining that content associated with the popup are downloaded to the client.

19. The system of claim 17 wherein the popup verification engine is further operable to redirect clients detected to have popup blocking to a network location that lacks popups.

20. The system of claim 17 wherein the popup verification engine is further operable to send a notice to the client that popup functionality is required.
